(19) United States
(12) Patent Application Publication
(10) Pub. No.: US 2023/0051291 A1
(43) Pub. Date: Feb. 16, 2023

(54) CARBON DIOXIDE FIXATION SYSTEM AND METHOD BY SEAWATER ELECTROLYSIS

(71) Applicant: KABUSHIKI KAISHA TOSHIBA, Tokyo (JP)

(72) Inventors: Kenji SANO, Inagi (JP); Hitomi SAITO, Tokyo (JP); Hirohisa MIYAMOTO, Kamakura (JP); Akiko SUZUKI, Tokyo (JP)

(73) Assignee: KABUSHIKI KAISHA TOSHIBA, Tokyo (JP)

(21) Appl. No.: 17/651,991

(22) Filed: Feb. 22, 2022

(30) Foreign Application Priority Data
Aug. 11, 2021 (JP) 2021-131156

(51) Int. Cl. C25B 1/20; C25B 13/00; C02F 1/44; C01B 32/50; C01F 5/24

(52) U.S. Cl. CPC C25B 1/20; C25B 13/00; C02F 1/441; C01B 32/50; C01F 5/24; C02F 2103/08

(57) ABSTRACT

According to one embodiment, there is provided a carbon dioxide fixation system includes an electrolytic cell and a settling tank. An electrolytic cell electrolyzes seawater to generate sodium hydroxide (NaOH). A settling tank mixes the sodium hydroxide generated in the electrolytic cell, concentrated seawater, and carbon dioxide (CO₂) to precipitate magnesium carbonate in which the carbon dioxide is fixed to magnesium (Mg) contained in the concentrated seawater.

### CROSS-REFERENCE TO RELATED APPLICATIONS

This application is based upon and claims the benefit of priority from Japanese Patent Application No. 2021-131156, filed Aug. 11, 2021, the entire contents of which are incorporated herein by reference.

### FIELD

Embodiments described herein relate generally to a carbon dioxide fixation system and method by seawater electrolysis.

### BACKGROUND

In recent years, there have been frequent meteorological disasters due to global warming, and reducing CO₂, which is a greenhouse gas, is an urgent need for humankind. Various methods have already been proposed and implemented for CO₂ reduction, but none of them can be said to be sufficient.

For example, carbon capture and storage (CCS) absorbs CO₂ emitted from a thermal power plant, etc. with an amine aqueous solution. However, heating the amine aqueous solution to release CO₂, and using the released CO₂ or releasing it deep in the ground and storing it in the stratum has been studied. Not many strata can store the released CO₂ by this method. Research is also underway to electrochemically reduce CO₂ to make it a valuable resource and recover it.

It is known that a strongly alkaline absorbing solution or an absorbing individual is required to efficiently capture CO₂. Of these, caustic soda (NaOH) is known as the strongest alkaline substance. NaOH is generated by electrolysis of salt water made with well-purified salt (NaCl) and fresh water. High-purity NaCl is used to obtain high-purity NaOH.

It is known that NaOH is generated by using the diaphragm of the cation exchange membrane by direct electrolysis of seawater. It is also known that NaOH reacts with CO₂ to form Na₂CO₃. Further, it is also known that Na₂CO₃ and MgCl₂ react in water to form basic magnesium carbonate. In particular, the latter is known as a method for producing basic magnesium carbonate.

If CO₂ reduction is performed without sufficient consideration, there is a risk that energy will be consumed and CO₂ will be released as a result. Therefore, it is desired to provide a technology that minimizes these problems and is also effective as a CCS.

### BRIEF DESCRIPTION OF THE DRAWINGS

FIG. 1 is a conceptual diagram showing a configuration example of a carbon dioxide fixation system to which a carbon dioxide fixation method of a first embodiment is applied.

FIG. 2A is a flowchart showing a reaction flow in an electrolytic cell of the carbon dioxide fixation system of the first embodiment.

FIG. 2B is a flowchart showing a reaction flow in a settling tank of the carbon dioxide fixation system of the first embodiment.

FIG. 3 is a conceptual diagram showing a configuration example of a carbon dioxide fixation system to which a carbon dioxide fixation method of a second embodiment is applied.

FIG. 4 is a conceptual diagram showing a configuration example of a carbon dioxide fixation system to which a carbon dioxide fixation method of a third embodiment is applied.

FIG. 5 is a conceptual diagram showing a configuration of a device used in an experiment in an example.

FIG. 6 is a table showing temporal experimental conditions.

FIG. 7 is a graph showing a temporal change in pH on a cathode side.

FIG. 8 is a diagram showing an IR spectrum obtained from a crystal.

### DETAILED DESCRIPTION

Hereinafter, a carbon dioxide fixation system and method of each embodiment of the present invention will be described with reference to the drawings.

A carbon dioxide fixation system of the embodiment includes an electrolytic cell and a settling tank. An electrolytic cell electrolyzes seawater to generate sodium hydroxide (NaOH). A settling tank mixes the sodium hydroxide generated in the electrolytic cell, concentrated seawater, and carbon dioxide (CO₂) to precipitate magnesium carbonate in which the carbon dioxide is fixed to magnesium (Mg) contained in the concentrated seawater.

In the following descriptions of the embodiments, the same components will be denoted by the same reference signs, and repeat descriptions will be omitted.

### First Embodiment

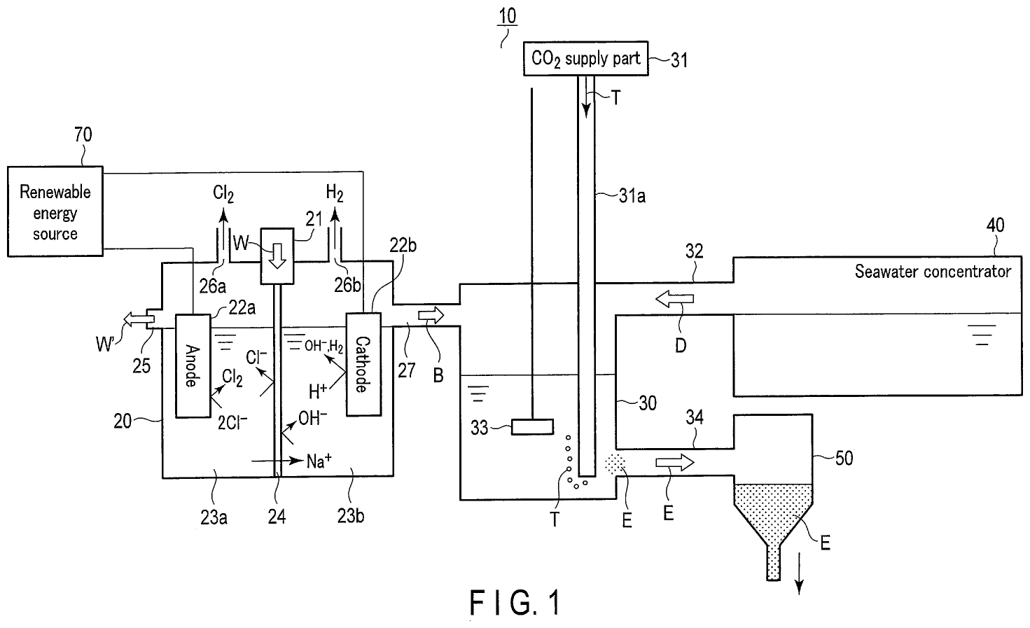

FIG. 1 is a conceptual diagram showing a configuration example of a carbon dioxide fixation system to which a carbon dioxide fixation method of a first embodiment is applied.

A carbon dioxide fixation system 10 includes an electrolytic cell 20, a settling tank 30, a seawater concentrator 40, and a precipitate recovery device 50.

Seawater W, which is water of the sea, is composed of water as a main component, a salt content of about 3.5 wt %, and a trace metal. The electrolytic cell 20 electrolyzes such seawater W to generate sodium hydroxide (NaOH).

Therefore, the electrolytic cell 20 is provided with a seawater introduction part 21 for introducing the seawater W, and a pair of electrodes including an anode 22a and a cathode 22b are arranged inside the electrolytic cell 20. Further, a cation exchange membrane 24 is provided so as to partition an anode side 23a in which the anode 22a is arranged and a cathode side 23b in which the cathode 22b is arranged.

The seawater W introduced into the electrolytic cell 20 from the seawater introduction part 21 is stored in the electrolytic cell 20.

The electrolytic cell 20 is also provided with an excess water discharge pipe 25 for discharging excessively introduced excess seawater W′ to the outside of the electrolytic cell 20. Installation of the excess water discharge pipe 25 is optional.

By providing the excess water discharge pipe 25, a liquid level of the seawater W stored in the electrolytic cell 20 can be maintained at not more than the height at which the excess water discharge pipe 25 is provided.

A material of the electrode composed of the anode 22a and the cathode 22b is not particularly limited as long as it is a conductive substance, and for example, iron (Fe), carbon (C), or an alloy can be applied.

When a current is passed from an energy source 70 to the electrode in a state where the seawater W is stored at a liquid level higher than a lower end of the electrode, a reaction shown in the following reaction formula (1) occurs on the anode 22a side. It is desirable to use renewable energy obtained from air volume, sunlight, etc. for the energy source 70. In particular, by using the surplus renewable energy on the grid, it is possible to avoid power generation accompanied by the generation of CO₂.

Anodic reaction 2Cl⁻→Cl₂+2e⁻ (1)

Since chlorine gas is generated in this way, a release hole 26a is provided in an upper portion of the anode side 23a of the electrolytic cell 20, and the chlorine gas exits the electrolytic cell 20 from the release hole 26a.

On the other hand, on the cathode 22b side, a reaction shown in the following reaction formula (2) occurs.

Cathodic reaction 2Na⁺+2H₂O+2e⁻→2NaOH+H₂ (2)

Since hydrogen gas is generated in this way, a release hole 26b is provided in an upper portion of the cathode side 23b of the electrolytic cell 20, and the hydrogen gas exits the electrolytic cell 20 from the release hole 26b.

The chlorine gas and hydrogen gas emitted from the release holes 26a and 26b to the outside of the electrolytic cell 20 can be appropriately treated as valuable resources by existing methods and facilities.

Considering the above-described reaction formulas (1) and (2), reactions shown in the following reaction formulas (3) and (4) occur inside the electrolytic cell 20.

Reaction in electrolytic cell 2NaOH+Cl₂→NaCl+NaClO+H₂O (3)

Total reaction NaCl+2H₂O NaClO+H_{2↑} (4)

As described above, when the seawater W is simply electrolyzed in the electrolytic cell 20, the generated chlorine (Cl) reacts with NaOH to form sodium hypochlorite (NaClO).

If nothing is done, the generated NaOH will be consumed and the solution will not become alkaline, so it will not be possible to capture CO₂.

To prevent this from happening, the electrolytic cell 20 is provided with the cation exchange membrane 24. As a result, the solution is kept alkaline, and only the cation Na⁺ can pass through the cation exchange membrane 24 and move from the anode side 23a to the cathode side 23b, and it binds to hydroxide ion (OH⁻) generated at the cathode 22b on the cathode side 23b to generate NaOH without mixing the products of the anode and cathode.

The electrolytic cell 20 is also provided with a transfer pipe 27 for transferring an aqueous solution of the generated NaOH (hereinafter, referred to as a “NaOH aqueous solution”) to the settling tank 30. In this way, the NaOH aqueous solution B is introduced into the settling tank 30 through the transfer pipe 27.

It is desirable that the electrolytic cell 20 be operated so that an amount of seawater W introduced from the seawater introduction part 21 and an amount of the NaOH aqueous solution B discharged from the transfer pipe 27 are the same. Further, it is desirable that the electrolytic cell 20 be provided with a pH meter (not shown), and that the electrolytic cell 20 be operated while monitoring to ensure that the pH of the aqueous solution stored in the electrolytic cell 20 is 10 or more by the pH meter.

In addition to the introduction of the NaOH aqueous solution B from the electrolytic cell 20 into the settling tank 30, concentrated seawater D is also introduced from the seawater concentrator 40.

Thus, a concentrated seawater introduction pipe 32 for introducing the concentrated seawater D from the seawater concentrator 40 is connected to the settling tank 30.

The seawater concentrator 40 can be realized by, for example, a salting out system or an RO device using an RO membrane (reverse osmosis membrane) (see the second embodiment), but may be any other device as long as it has a function of concentrating the seawater W. Such a seawater concentrator 40 generates, for example, the concentrated seawater D in which seawater is twice concentrated in order to supply the settling tank 30 with a sufficient amount of magnesium (Mg) for fixing CO₂. Incidentally, the magnesium concentration in normal seawater is about 3.7% of the solute weight, which is an average of 3.5% of the seawater weight, which is much smaller than the concentration of 30.6% of sodium. Calcium is about 1.2% of the solute weight. A salting out system can be used as the seawater concentrator 40. For example, if it can be easily separated from water by a membrane, etc., alcohol can be added to concentrate the salts by salt precipitation. In this case, electrolysis can be performed using slurry-like concentrated salts.

Further, CO₂ gas T is also introduced into the settling tank 30 from the carbon dioxide supply part 31. Thus, the settling tank 30 is also provided with a CO₂ introduction pipe 31a for introducing the CO₂ gas T supplied from the carbon dioxide supply part 31. The CO₂ gas T from the carbon dioxide supply part 31 exits from a distal end of the CO₂ introduction pipe 31a. Therefore, by immersing the distal end of the CO₂ introduction pipe 31a in the mixed water of the NaOH aqueous solution B and the concentrated seawater D, the CO₂ gas T can be supplied to the mixed water while bubbling in the mixed water.

The carbon dioxide supply part 31 preferably supplies, for example, the CO₂ gas T exhausted from a garbage incinerator or a thermal power plant.

Since the settling tank 30 is further provided with an agitator 33, the NaOH aqueous solution B, the concentrated seawater D, and the CO₂ gas T can be agitated in the settling tank 30 using the agitator 33. The settling tank 30 may or may not be provided with the agitator 33.

As described above, when the NaOH aqueous solution B, the concentrated seawater D, and the CO₂ gas T are agitated in the settling tank 30, sodium carbonate (Na₂CO₃) is generated as shown in the following reaction formula (5), and further, as shown in a reaction formula (6), sodium carbonate (Na₂CO₃) reacts with MgCl₂ in which magnesium ions and chlorine ions in the concentrated seawater D are bound in order to cause precipitating of basic magnesium carbonate (MgCO₃), and carbon dioxide gas is fixed.

2NaOH+CO₂→Na₂CO₃+H₂O (5)

Na₂CO₃+MgCl₂→2NaCl+MgCO_{3↓} (6)

As described above, in the settling tank 30, a precipitate E of magnesium carbonate (MgCO₃) in which CO₂ is fixed to magnesium (Mg) contained in the concentrated seawater D is generated by mixing the NaOH aqueous solution B, the concentrated seawater D, and CO₂.

Since the reactions shown in (5) and (6) above also occur at a saturated salt concentration of 26% NaCl, they occur independently of the concentration of NaCl.

In the above (6), the precipitate E is represented by a simplified magnesium carbonate such as MgCO₃, but it is considered that basic magnesium carbonate involving magnesium hydroxide and water crystals is actually generated as shown in the following formulae.

3MgCO₃.Mg(OH)₂.3H₂O(hydromagnesite)

4MgCO₃.Mg(OH)₂.4H₂O(hydromagnesite)

MgCO₃.Mg(OH)₂.3H₂O(artinite)

4MgCO₃Mg(OH)₂.5H₂O(dypingite)

4MgCO₃.Mg(OH)₂.5H₂O(giorgiosite)

4MgCO₃Mg(OH)₂.8H₂O

A precipitate discharge pipe 34 for discharging the generated precipitate E to the precipitate recovery device 50 is provided near a bottom portion of the settling tank 30, and the generated precipitate E is discharged to the precipitate recovery device 50 through the precipitate discharge pipe 34 and recovered by the precipitate recovery device 50.

Next, an operation example of the carbon dioxide fixation system to which the carbon dioxide fixation method of the first embodiment formed as described above is applied will be described.

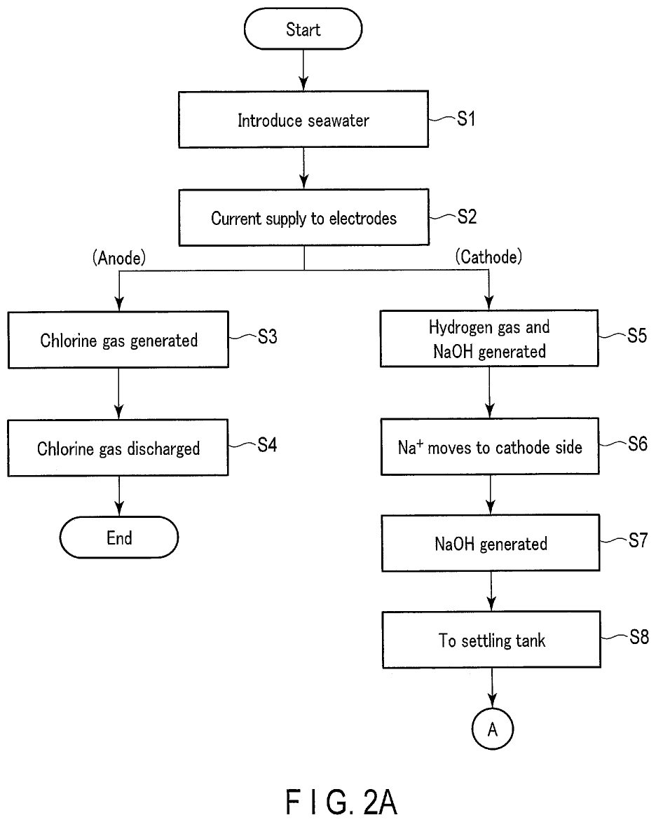

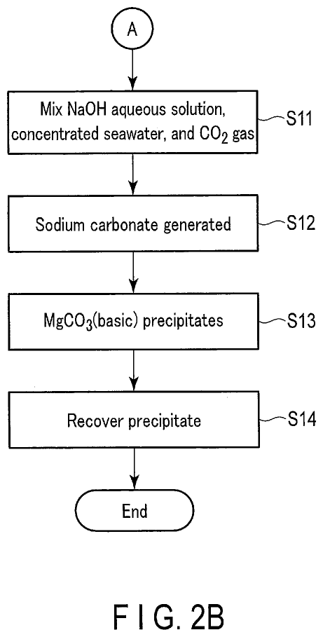

FIG. 2A is a flowchart showing a flow of the reactions in the electrolytic cell of the carbon dioxide fixation system of the first embodiment.

The carbon dioxide fixation system 10 realizes an alkaline environment by producing the NaOH aqueous solution B by direct electrolysis of seawater, and stably fixes CO₂ by basic magnesium carbonate generated by the reaction of Mg contained in the concentrated seawater D with Na₂CO₃ under this alkaline environment.

In order to realize this, first, the seawater W is introduced into the electrolytic cell 20 from the seawater introduction part 21 (S1). As a result, the seawater W is stored in the electrolytic cell 20. The introduction of the seawater W may be intermittent, but continuous introduction is preferable for uniform electrolytic treatment. The electrolytic cell 20 may also be provided with the excess water discharge pipe 25. By providing the excess water discharge pipe 25, when the liquid level reaches the excess water discharge pipe 25, the excess seawater W′ in the electrolytic cell 20 is discharged from the excess water discharge pipe 25 to the outside of the electrolytic cell 20. The liquid level of the seawater W stored in the electrolytic cell 20 can thus be maintained at not more than the height at which the excess water discharge pipe 25 is provided.

Inside the electrolytic cell 20, a pair of electrodes including the anode 22a and the cathode 22b are arranged. Further, the cation exchange membrane 24 is provided so as to partition the anode side 23a in which the anode 22a is arranged and the cathode side 23b in which the cathode 22b is arranged.

With the seawater W stored in the electrolytic cell 20, for example, a current is supplied from the renewable energy source 70 such as wind power and sunlight to the electrodes 22a and 22b (S2).

As a result, chlorine gas is generated on the anode 22a side according to the above-described reaction formula (1) (S3). Chlorine gas is discharged to the outside of the electrolytic cell 20 from the release hole 26a (S4).

On the other hand, on the cathode 22b side, the hydrogen gas and the NaOH aqueous solution B are generated according to the above-described reaction formula (2) (S5). The hydrogen gas is discharged to the outside of the electrolytic cell 20 from the release hole 26b.

That is, inside the electrolytic cell 20, the reactions represented by the above-described reaction formulae (3) and (4) occur. Here, according to the reaction formula (3), NaOH is consumed and sodium hypochlorite (NaClO) is generated, which is not preferable from the viewpoint of maintaining alkalinity.

In order to compensate for this, in the electrolytic cell 20, as described below, the introduction of the cation exchange membrane 24 promotes the production of NaOH, so that the consumption of NaOH according to the reaction formula (3) is compensated and the solution in the electrolytic cell 20 can be kept alkaline.

That is, since only the cation Na⁺ contained in the seawater W can pass through the cation exchange membrane 24, a movement of Na⁺ from the anode side 23a to the cathode side 23b occurs (SG). Na⁺ binds to the hydroxide ion (OH⁻) generated at the cathode 22b on the cathode side 23b to generate NaOH (S7). As a result, the consumption of NaOH according to the reaction formula (3) is compensated for, and the alkalinity of the solution in the electrolytic cell 20 is maintained.

The NaOH aqueous solution B thus generated is introduced into the settling tank 30 through the transfer pipe 27 (S8).

FIG. 2B is a flowchart showing a flow of the reactions in the settling tank of the carbon dioxide fixation system of the first embodiment.

Mixing is promoted by introducing the NaOH aqueous solution B from the electrolytic cell 20, the concentrated seawater D from the seawater concentrator 40, and the CO₂ gas from the carbon dioxide supply part 31 into the settling tank 30 and agitating them with the agitator 33 (S11).

As a result, sodium carbonate (Na₂CO₃) is generated according to the above-described reaction formula (5) (S12).

Further, according to the reaction formula (6), sodium carbonate (Na₂CO₃) reacts with MgCl₂ in which magnesium ions and chlorine ions in the concentrated seawater D are bound so as to result in the precipitate E of basic magnesium carbonate, and carbon dioxide gas is fixed (S13).

Since the reactions shown in (5) and (6) above occur even at a saturated salt concentration of 26%, they occur independently of the concentration of NaCl.

On the other hand, an experiment was conducted to see how dilute the magnesium concentration was so that the precipitate E could be visually observed. The fact that it is not visible means that the precipitate E is almost not generated at all, or if it is generated, it is not a significant amount. As a result of the experiment, it was possible to visually confirm that there was up to 2 wt % when using magnesium chloride hexahydrate. This is 0.24 wt % in terms of magnesium (Mg²⁺). Since 0.13 wt % of Mg²⁺ is present in seawater, the magnesium concentration of 0.24 wt % corresponds to about twice the magnesium concentration in seawater. It is on this basis that the concentration of the concentrated seawater D is set to be equal to or more than twice the concentration of seawater.

The precipitate discharge pipe 34 for discharging the generated precipitate E to the precipitate recovery device 50 is provided near the bottom portion of the settling tank 30, and the generated precipitate E is discharged to the precipitate recovery device 50 through the precipitate discharge pipe 34 and recovered by the precipitate recovery device 50 (514).

In the above, for the sake of simplicity, the flowchart divided into FIGS. 2A and 2B is used, and each step is shown separately, but all the steps shown in FIGS. 2A and 2B may be performed simultaneously and continuously instead of being performed independently and separately. Since it suffices that the steps are performed in the order shown in FIGS. 2A and 2B, the steps may be continuous or, for example, time may occur between the steps and the steps may be intermittent.

As described above, according to the carbon dioxide fixation system to which the carbon dioxide fixation method of the first embodiment is applied, the production of NaOH by the direct electrolysis of seawater can prevent CO₂ from being generated during the production of NaOH and realize an alkaline environment.

Further, under this alkaline environment, basic magnesium carbonate can be generated by the reaction of Mg contained in the concentrated seawater with Na₂CO₃. Since basic magnesium carbonate precipitates, in addition to being able to stably fix CO₂, basic magnesium carbonate can also immobilize CO₂ in the air and transform it into magnesium carbonate when left in a moist state.

In this way, the carbon dioxide fixation system to which the carbon dioxide fixation method of the present embodiment is applied can easily realize both the arrangement of alkali and the efficient fixation of carbon dioxide by applying the direct electrolysis of seawater and utilizing the existing reactions.

### Second Embodiment

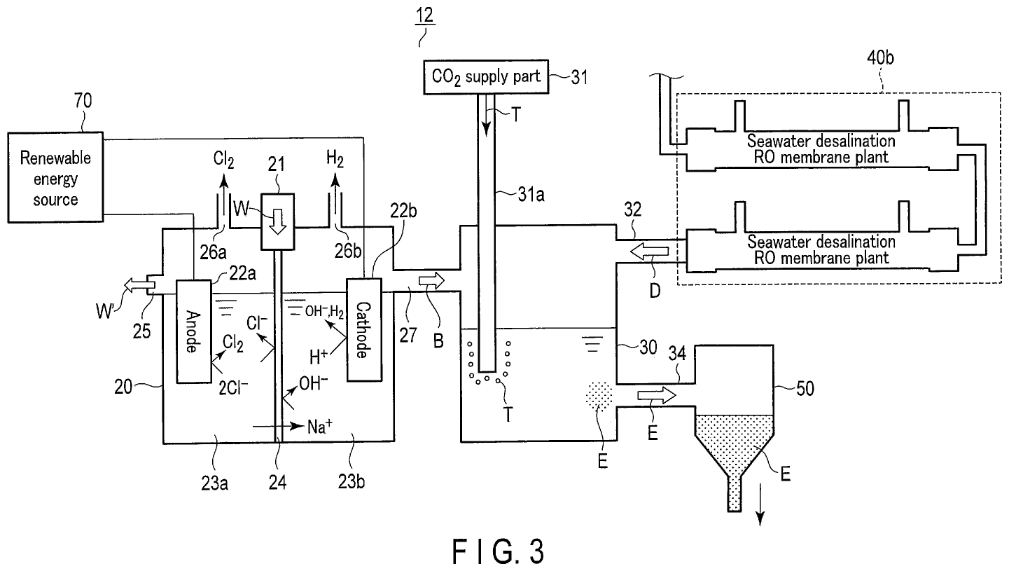

FIG. 3 is a conceptual diagram showing a configuration example of a carbon dioxide fixation system to which a carbon dioxide fixation method of a second embodiment is applied.

A carbon dioxide fixation system 12 of the second embodiment exemplified in FIG. 3 shows an example in which multiple stages of seawater-desalination reverse-osmosis membrane (RO membrane) plants 40b are applied to the seawater concentrator 40 in the carbon dioxide fixation system 10 of the first embodiment exemplified in FIG. 1.

The multiple stages of seawater-desalination reverse-osmosis membrane (RO membrane) plants 40b can be seawater desalination plants to which the RO membrane is applied. In this type of seawater desalination plant, high-pressure seawater passes through multiple stages of RO membranes. The seawater is becomes more dilute each time it passes through the RO membrane, and finally fresh water is generated, but at the same time, the concentrated seawater D is also generated as reject water.

In a seawater desalination plant, it is environmentally unfavorable to let the concentrated seawater D generated as reject water flow into the sea as it is.

Therefore, in the present embodiment, the concentrated seawater D generated as reject water in the seawater desalination plant is utilized and introduced into the settling tank 30. As described in the first embodiment, the concentrated seawater D is assumed to be the seawater W concentrated twice or more so that the magnesium concentration is equal to or more than twice that in the seawater W. Therefore, the number of stages of the seawater-desalination reverse-osmosis membrane (RO membrane) plants 40b may be any number as long as it can double or more than double the concentration of the seawater W.

Even in this case, magnesium is supplied to the settling tank 30, so that magnesium carbonate precipitates in the settling tank 30.

Accordingly, the carbon dioxide fixation system to which the carbon dioxide fixation method of the second embodiment is applied can also easily realize both the arrangement of alkali and the efficient fixation of carbon dioxide by applying the direct electrolysis of seawater and utilizing the existing reactions in the same manner as in the first embodiment.

### Third Embodiment

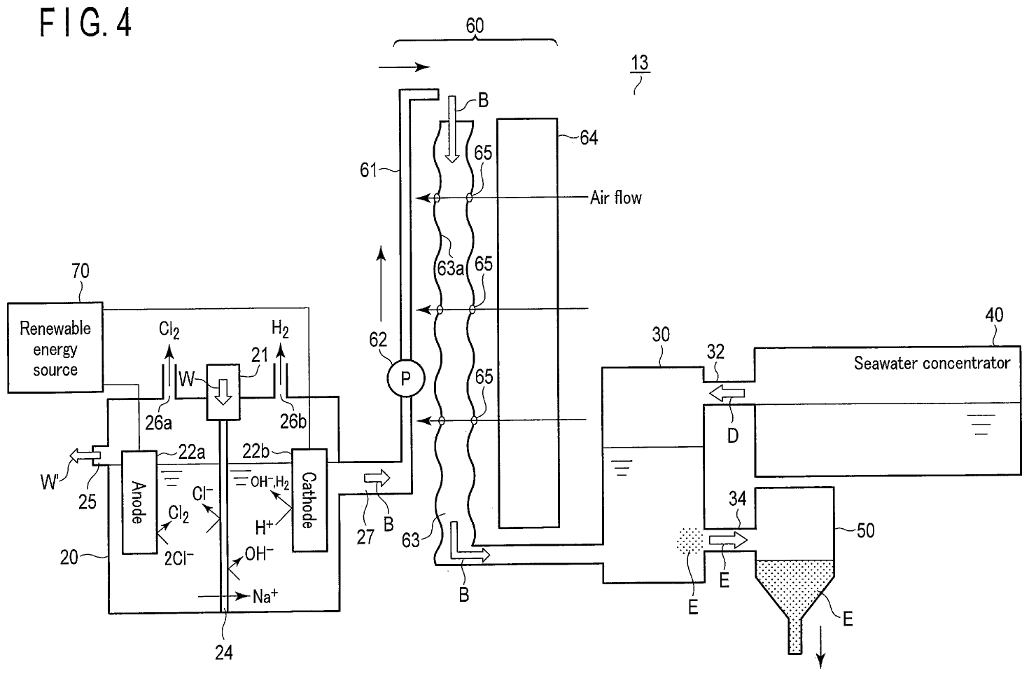

FIG. 4 is a conceptual diagram showing a configuration example of a carbon dioxide fixation system to which a carbon dioxide fixation method according to a third embodiment is applied.

A carbon dioxide fixation system 13 of the third embodiment exemplified in FIG. 4 has a configuration in which an air contactor 60 is provided between the electrolytic cell 20 and the settling tank 30 in the carbon dioxide fixation system 10 of the first embodiment exemplified in FIG. 1 while the carbon dioxide supply part 31 and the CO₂ introduction pipe 31a are deleted. The air contactor 60 includes an introduction pipe 61, a pump 62, a cylindrical part 63, and a blower 64.

The introduction pipe 61 is a pipe that connects the transfer pipe 27 and an upper end of the upright cylindrical part 63.

The introduction pipe 61 is provided with the pump 62.

The pump 62 causes the NaOH aqueous solution B discharged from the transfer pipe 27 to rise inside the introduction pipe 61, and introduces the NaOH aqueous solution B from an upper end of the cylindrical part 63 into the inside of the cylindrical part 63.

An inner cylinder surface of the cylindrical part 63 has a corrugated plate shape that undulates in a long direction (i.e., the vertical direction in the figure) of the cylinder, and the NaOH aqueous solution B introduced into the inside of the cylinder from the upper end of the cylindrical part 63 slowly descends inside the cylindrical part 63 due to its own weight while following a surface of a corrugated plate 63a. Many through holes 65 are formed on the surface of the cylindrical part 63.

It is preferable that the blower 64 be arranged in the vicinity of the cylindrical part 63, and be able to blow air toward the cylindrical part 63 over the entire height of the cylindrical part 63 in order for the NaOH aqueous solution B that slowly descends inside the cylindrical part 63 while following the surface of the corrugated plate 63a to efficiently and directly capture CO₂ present at a ratio of 400 ppm in the air. Therefore, the blower 64 preferably has a higher effective height than the cylindrical part 63, and is preferably an upright type like the cylindrical part 63.

Since many through holes 65 are provided on the surface of the cylindrical part 63, the air blown by the blower 64 enters the inside of the cylindrical part 63 through these through holes 65 and contacts the NaOH aqueous solution B that descends inside the cylindrical part 63. Inside the cylindrical part 63, the NaOH aqueous solution B descends while following the surface of the corrugated plate 63a, so that a surface area ratio of the NaOH aqueous solution B is increased by the corrugated plate 63a, and a contact efficiency with the air is improved. As described above, the corrugated plate 63a has an effect of allowing the NaOH aqueous solution B to slowly descend and also an effect of increasing the surface area ratio of the NaOH aqueous solution B. By these two effects, the contact efficiency between the NaOH aqueous solution B and the air is enhanced in the cylindrical part 63. The configuration of the cylindrical part 63 is not limited to the configuration provided with the corrugated plate 63a, and any other configuration may be used as long as the contact efficiency between the NaOH aqueous solution B and the air can be enhanced.

Since the air contactor may be provided with a member capable of lowering the NaOH aqueous solution B, the member is not limited to a cylindrical part or a corrugated shape. The shape may be such that the NaOH aqueous solution B is transmitted to a member such as a rain chain and the wind directly sent from the blower hits the member.

It is also preferable to use the renewable energy source 70 as a power source for the pump 62 and the blower 64.

As described above, since the NaOH aqueous solution B efficiently contacts the air in the cylindrical part 63, it is transferred to the settling tank 30 with sufficient CO₂. Then, in the settling tank 30, the sodium carbonate aqueous solution is generated according to the chemical reaction shown in the above-described formula (5), and further the chemical reaction shown in the above-described (6) occurs, and CO₂ is fixed.

Since the NaOH aqueous solution B accompanied by CO₂ is supplied to the settling tank 30 in this way in the carbon dioxide fixation system 13, the carbon dioxide supply part 31 and the CO₂ introduction pipe 31a provided for supplying CO₂ to the settling tank 30 in the carbon dioxide fixation systems 10 and 12 are not required.

As described above, the seawater concentrator 40 is not limited to a specific device as long as it has a function of concentrating the seawater W as described above, and for example, a salting out system or the multiple-staged seawater-desalination reverse-osmosis membrane (RO membrane) plants 40b shown in FIG. 3 can also be applied.

In addition, in FIG. 4, the electrolytic cell 20 is also provided with the excess water discharge pipe 25 for discharging the excessively introduced seawater W to the outside of the electrolytic cell 20 as in the other embodiments. Thus, by introducing more seawater W than the amount of the NaOH aqueous solution B recovered by the pump 62 into the electrolytic cell 20 from the seawater introduction part 21, the water level of the seawater W in the electrolytic cell 20 is kept constant, and the NaOH aqueous solution B can be stably supplied to the cylindrical part 63.

Further, as a modification for the configuration illustrated in FIG. 4, the electrolytic cell 20 is not provided with the excess water discharge pipe 25, and instead, a water level gauge (not shown) is installed in the electrolytic cell 20, and a supply amount of the seawater W from the seawater introduction part 21 and a discharge amount of the pump 62 may be controlled while confirming that the water level in the electrolytic cell 20 is constant by the water level gauge.

As described above, the carbon dioxide fixation system to which the carbon dioxide fixation method of the third embodiment is applied can also easily realize both the arrangement of alkali and the efficient fixation of carbon dioxide by applying the direct electrolysis of seawater and utilizing the existing reactions, in the same manner as in the first embodiment.

### Example

In order to confirm the effect described in the first to third embodiments, a result of an experiment carried out using a simple device to which the principle described in the first to third embodiments is applied is shown below as an example.

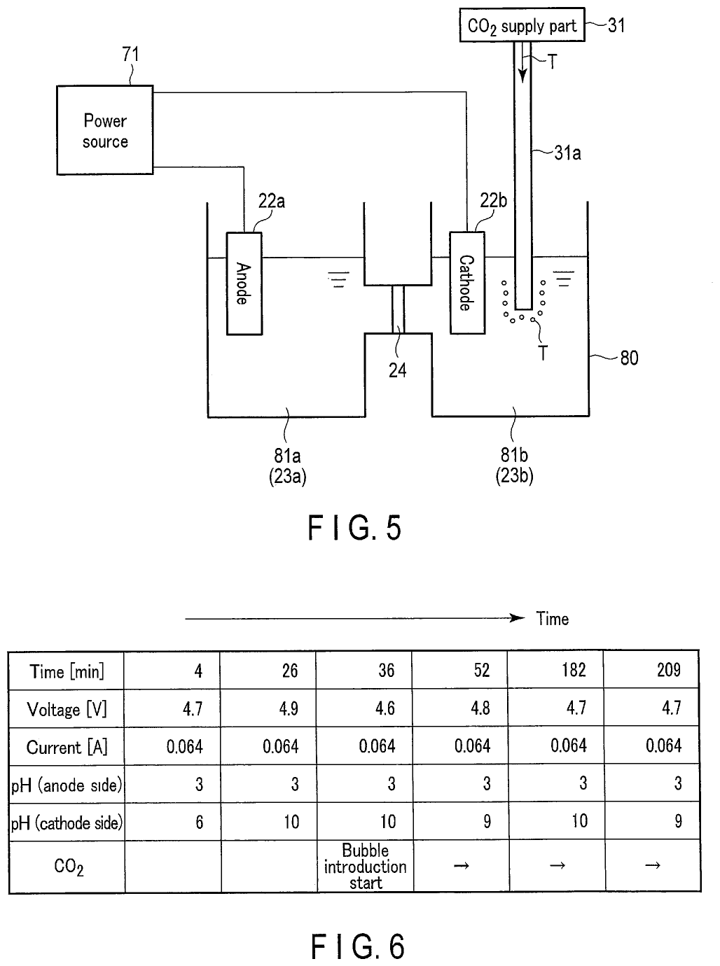

FIG. 5 is a conceptual diagram showing a configuration of a device used in the experiment in the present example.

Also in FIG. 5, the same components as those described in any one of the first to third embodiments will be denoted by the same reference signs, and a repeat description will be omitted.

First, 16 g of salt and 50 g of magnesium chloride hexahydrate were dissolved in 200 g of water to prepare an electrolytic solution model. This solution was placed in each of a left cell 81a and a right cell 81b of an H-type cell 80 separated by the cation exchange membrane 24.

Next, carbon rods were placed in the left cell 81a and the right cell 81b so as to be immersed in the solution.

A power supply 71 was connected to both carbon rods so that the carbon rod of the left cell 81a became the anode 22a and the carbon rod of the right cell 81b became the cathode 22b. Then, by supplying electric power from the power source 71, the left cell 81a becomes the anode side 23a and the right cell 81b becomes the cathode side 23b.

FIG. 6 is a table showing temporal experimental conditions.

As shown in FIG. 6, a current fixed at 64 mA was supplied from the power source 71, electrolysis was performed while confirming that a voltage is almost constant, and pH was measured on both the anode side 23a and the cathode side 23b. Since chlorine is generated from the cathode side 23b by electrolysis, the experiment was carried out by arranging the H-type cell 80 in a draft.

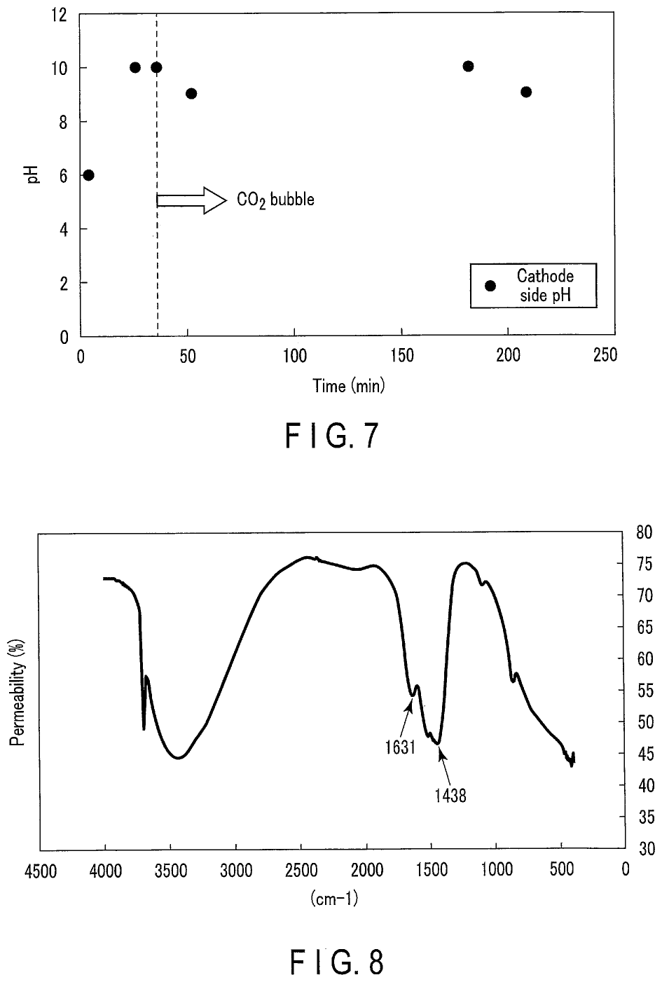

FIG. 7 is a graph showing a temporal change in pH on the cathode side.

36 minutes after the start of the experiment, it was confirmed that the anode side 23a became acidic near pH=3 and the cathode side 23b became alkaline near pH=10, and the distal end of the CO₂ introduction pipe 31a was immersed in the solution of the cathode side 23b and the CO₂ gas T was slowly supplied to the solution of the cathode side 23b from the carbon dioxide supply part 31 through the CO₂ introduction pipe 31a, so that bubbling due to the CO₂ gas T was started. When bubbling speed is high, the pH of the cathode side 23b becomes acidic, so the bubbling was performed at a slow speed so that the pH of the cathode side 23b did not become 9 or less.

Then, 200 minutes after the start of the experiment, the power supply from the power source 71 was stopped, and the electrolysis was completed. Then, crystals attached to the carbon rod, which was the cathode 22b, were scraped off, dried, and then a weight of the crystals and an IR spectrum were measured. The weight obtained by this weight measurement was 155 mg.

FIG. 8 is a diagram showing the IR spectrum obtained from the crystals.

From FIG. 8, it was confirmed that the crystals had a strong peak of 1631 cm⁻¹ to 1438 cm⁻¹ in the IR spectrum, and that basic magnesium carbonate was generated.

As described above, it was possible to demonstrate that, by the principle described in the first to third embodiments, an alkaline environment was realized by electrolysis and basic magnesium carbonate capable of fixing CO₂ could be generated under this alkaline environment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A carbon dioxide fixation system comprising:
an electrolytic cell configured to electrolyze seawater to generate sodium hydroxide (NaOH); and
a settling tank configured to mix the sodium hydroxide generated in the electrolytic cell, concentrated seawater, and carbon dioxide (CO₂) so as to precipitate magnesium carbonate in which the carbon dioxide is fixed to magnesium (Mg) contained in the concentrated seawater.

2. The carbon dioxide fixation system according to claim 1, wherein
a cation exchange membrane is provided inside the electrolytic cell so as to partition an anode side and a cathode side, and
in the electrolytic cell, a sodium ion (Na⁺) generated on the anode side by electrolyzing the seawater passes through the cation exchange membrane, moves to the cathode side, and binds with a hydroxide ion (OH⁻) generated on the cathode side to generate the sodium hydroxide.

3. The carbon dioxide fixation system according to claim 1, further comprising a seawater concentration part configured to supply the concentrated seawater to the settling tank.

4. The carbon dioxide fixation system according to claim 3, wherein the seawater concentration part is configured to concentrate seawater using a reverse osmosis membrane.

5. The carbon dioxide fixation system according to claim 3, wherein the seawater concentration part is a salting out system.

6. The carbon dioxide fixation system according to claim 1, further comprising a carbon dioxide supply part configured to supply carbon dioxide mixed with the sodium hydroxide to the settling tank.

7. The carbon dioxide fixation system according to claim 1, further comprising a blower configured to, in order to accompany the sodium hydroxide generated in the electrolytic cell with the carbon dioxide to be mixed in the settling tank, blow air toward the sodium hydroxide before being supplied to the settling tank.

8. The carbon dioxide fixation system according to claim 1, further comprising a precipitate recovery part configured to recover the magnesium carbonate precipitated in the settling tank.

9. A carbon dioxide fixation method comprising:
electrolyzing seawater to generate sodium hydroxide; and
mixing the sodium hydroxide, concentrated seawater, and carbon dioxide to precipitate basic magnesium carbonate in which the carbon dioxide is fixed to magnesium contained in the concentrated seawater.
